(19) United States
(12) Patent Application Publication
(10) Pub. No.: US 2026/0227167 A1
(43) Pub. Date: Aug. 6, 2026

(54) SYSTEMS AND METHODS FOR DETERMINING DIMENSIONS OF ITEMS

(71) Applicant: Walmart Apollo, LLC, Bentonville, AR (US)

(72) Inventors: Michael J. Klingman, Gentry, AR (US); Grant Resler, Rogers, AR (US); Arifa Sultana, Bentonville, AR (US); Tomas A. Blodgett, Fayetteville, AR (US)

(21) Appl. No.: 19/042,506

(22) Filed: Jan. 31, 2025

(51) Int. Cl. G01B 3/20

(52) U.S. Cl. CPC G01B 3/20

(57) ABSTRACT

In some embodiments, apparatuses and methods are provided herein useful to determine dimensions of items. In some embodiments, a system may include a plurality of caliper plates, wherein a location of each of the plurality of caliper plates is adjustable along a respective axis, a plurality of sensors, wherein at least one sensor of the plurality of sensors is positioned to detect a range of movement of each of the caliper plates, a user interface including a display, and a control circuit that: obtains, from the at least one sensor, measurement data indicating a distance moved by each of the caliper plates along their respective axis from an initial position to a final position, where each of the caliper plates is in contact with a respective side of an item; and processes the measurement data received from the at least one sensor to determine overall dimensions of the item.

### TECHNICAL FIELD

This disclosure relates generally to item measurement devices, and, more particularly, to devices for determining dimensions of the items.

### BACKGROUND

During supply chain processes, item dimensions are used to determine the eligibility of an item for induction within automated systems. Receiving precise dimensions can be integral in determining the eligibility of an item to enter an automated system and may result in automated process optimization and enhanced reliability thereafter. Conventional item measurement devices are limited in terms of accuracy of the dimensions determined (e.g., due to undetected packaging imperfections), are not easy to operate, are not easy to deploy within a supply chain, and have a high cost. As such, a need exists for systems and methods that can determine dimensions of items effectively and cost-efficiently.

### BRIEF DESCRIPTION OF DRAWINGS

Disclosed herein are embodiments of systems, apparatuses and methods pertaining to determining dimensions of items. This description includes drawings, wherein:

FIG. 1A is a perspective view of a measurement system in accordance with some embodiments.

FIG. 1B is a flow diagram showing a method of item measurement in accordance with several embodiments.

FIG. 2A is a perspective view of a measurement system in accordance with some embodiments.

FIG. 2B is a flow diagram showing a method of item measurement in accordance with several embodiments.

FIG. 3 is a block diagram of a measurement system in accordance with some embodiments.

FIG. 4A is a flow diagram showing a method of item measurement in accordance with several embodiments.

FIG. 4B is a flow diagram showing a method of item measurement in accordance with some embodiments.

FIG. 4C is a flow diagram showing a method of item measurement in accordance with several embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments. Also, common but well-understood elements that are useful or necessary in a commercially feasible embodiment are often not depicted in order to facilitate a less obstructed view of these various embodiments. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses, and methods are provided herein useful to determine dimensions of items. In some embodiments, a system includes: a plurality of caliper plates, wherein a location of each of the plurality of caliper plates is adjustable along a respective axis; a plurality of sensors, wherein at least one sensor of the plurality of sensors is positioned to detect a range of movement of each of the caliper plates; a user interface including a display; and a control circuit that: obtains, from the at least one sensor, measurement data indicating a distance moved by each of the caliper plates along their respective axis from an initial position to a final position, where each of the caliper plates is in contact with a respective side of an item; and processes the measurement data received from the at least one sensor to determine overall dimensions of the item.

In some embodiments, a method for determining dimensions of items includes: adjusting a location of a plurality of caliper plates, wherein a location of each of the plurality of caliper plates is adjustable along a respective axis; providing a user interface including a display; obtaining, by a control circuit, from at least one sensor, of a plurality of sensors, positioned to detect a range of movement of each of the caliper plates, measurement data indicating a distance moved by each of the caliper plates along their respective axis from an initial position to a final position, where each of the caliper plates is in contact with a respective side of an item; and processing, by the control circuit, the measurement data received from the at least one sensor to determine overall dimensions of the item.

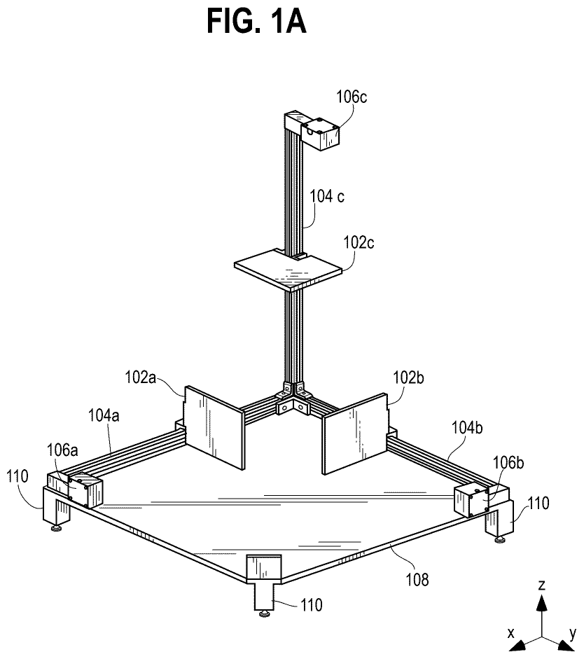

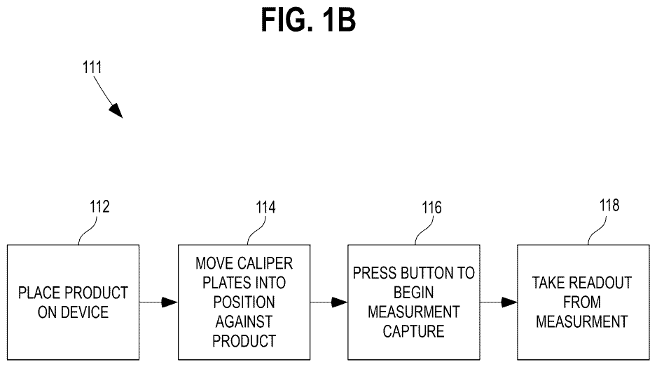

FIG. 1A illustrates a system 100 for determining item dimensions in accordance with some embodiments. In some aspects, the system 100 includes a plurality of caliper plates 102a, 102b, 102c, a plurality of sensors 106a, 106b, 106c, a platform 108, and supports 110. In some embodiments, the system 100 is a manual system, and each of the caliper plates 102a, 102b, 102c is manually adjusted by an operator (e.g., automated (e.g., robotic) and/or human). Generally, the system 100 is used within a supply chain (e.g., at a warehouse of a retailer) in order to determine dimensions of items entering the supply chain. In some aspects, the items are packaged (e.g., in boxes, bags, shrink-wrap, tape, etc.) such that an item for sale at a retailer is located within the packaging. It will be appreciated, however, that the system 100 may be used to determine the dimensions of items that are not enclosed in packaging.

The caliper plates 102a, 102b, 102c are generally surfaces for contacting items. While each caliper plate 102a, 102b, 102c is shown as a rectangular surface, it is generally contemplated that the caliper plates 102a, 102b, 102c may be any suitable alternate shape, size, and so forth. In some aspects, the caliper plates 102a, 102b, 102c are interchangeable such that a different physical variation of caliper plate 102a, 102b, 102c may be used depending on specific variations in item packing and/or shape. In some aspects, a location of each of the caliper plates 102a, 102b, 102c is adjustable along a respective rail 104a, 104b, 104c in a respective axis. As shown, the rails 104a, 104b, 104c are perpendicular to one another and correspond with the x-axis, y-axis, and z-axis depicted in the bottom right corner of FIG. 1A, respectively. While three rails 104a, 104b, 104c are shown in FIG. 1A, it is generally contemplated that there may be any alternate number of rails provided depending on the number dimensions being measured (i.e., one rail corresponds with one dimension (e.g., width, depth, height, etc.)).

Generally, the caliper plates 102a, 102b, 102c are movable along each of the respective rails 104a, 104b, 104c. As shown, each rail 104a, 104b, 104c may be a physical structure upon which the respective caliper plate 102a, 102b, 102c can move (e.g., by sliding, rotation, threading (i.e., rotation to translation), and so forth). In the shown embodiments, the caliper plates 102a, 102b, 102c are each slidable along a linear structure of the respective rail 104a, 104b, 104c from an initial position (e.g., adjacent the respective sensors 106a, 106b, 106c) to a final position (e.g., the intersection point of each of rails 104a, 104b, 104c). Generally, the maximum distance movable by a caliper plate 102a, 102b, 102c is from the initial position adjacent a first end of a respective rail 104a, 104b, 104c to the final position adjacent a second end of the respective rail 104a, 104b, 104c which is generally proximate an intersection point of the rail 104a, 104b, 104c.

In some aspects (not shown), the system 100 further includes a locking assembly to lock and maintain each of the caliper plates 102a, 102b, 102c in position. The locking assembly may include any suitable locking mechanism including lever handle locks, cam locks, deadbolt locks, cylindrical locks, latches, etc. Generally, the position of the caliper plates 102a, 102b, 102c may be locked by the locking assembly when each of the caliper plates 102a, 102b, 102c is in contact with a respective side of an item being measured. In some aspects, each of the caliper plates 102a, 102b, 102c is individually lockable by the locking assembly (i.e., such that one caliper plate may remain movable while another caliper plate is locked in place), while in some embodiments, each of the caliper plates 102a, 102b, 102c is unitarily lockable (i.e., such that all of the caliper plates are movable, or all of the caliper plates are locked).

The sensors 106a, 106b, 106c determine measurement data in accordance with some embodiments. The sensors 106a, 106b, 106c may be any suitable sensors including lidar sensors, ultrasonic sensors, rotary encoders, pressure sensors, and the like. Generally, each sensor 106a, 106b, 106c is positioned to detect a range of movement of a respective caliper plate 102a, 102b, 102c. In some aspects, a sensor 106a, 106b, 106c is directly coupled to a respective caliper plate 102a, 102b, 102c, while in some aspects (shown in FIG. 1A) the sensor 106a, 106b, 106c is spaced apart from a respective caliper plate 102a, 102b, 102c (e.g., at an initial position of a caliper plate 102a, 102b, 102c on a respective rail 104a, 104b, 104c). There may be any combination of sensors physically coupled to the caliper plates, and sensors located elsewhere on the system 100.

The platform 108 is generally a flat surface which supports an item being measured. As shown, the platform 108 is supported by supports 110. While FIG. 1A shows the platform 108 being supported by four supports 110 (three shown, one not shown), it is contemplated that in some aspects there may be any alternate suitable configuration, size, spacing, and/or number of supports 110 (e.g., one, two, three, five, etc.). In some forms, the system 100 may not require supports 110 to support the platform 108 (i.e., the supports 110 are optional in some embodiments). FIG. 1A shows the platform 108 being generally rectangular in shape and oriented in the plane defined by a first axis extending along a first rail 104a and a second axis extending along a first rail 104b, however, it is contemplated that the platform 108 may have any alternate suitable size, shape, and/or orientation. In some aspects, there may be additional surfaces similarly positioned in the planes defined by the second axis and a third axis extending along a third rail 104c and by the first axis and the third axis. In some aspects, the system 100 may not include a platform 108, and the system 100 and/or the item being measured may be supported on a conventional support surface that is not part of the system 100 during item measurement. In some embodiments, the system 100 may further include load cells configured to determine the mass of item supported on the platform 108.

In some embodiments, the caliper plates include a first caliper plate 102a, a second caliper plate 102b, and a third caliper plate 102c as shown in FIG. 1A. A range of movement of the first caliper plate 102a may be detected by the first sensor 106a, and a location of the first caliper plate 102a may be adjustable via movement of the first caliper plate 102a along a first rail 104a in a first axis. A range of movement of the second caliper plate 102b may be detected by the second sensor 106b, and a location of the second caliper plate 102b may be adjustable via movement of the second caliper plate 102b along a second rail 104b in a second axis. A range of movement of the third caliper plate 102c may be detected by the third sensor 106c, and a location of the third caliper plate 102c may be adjustable via movement of the third caliper plate 102c along a third rail 104c in a third axis. While three caliper plates 102a-102c adjustable along three respective rails 104a-104c in three respective axes is shown, it is contemplated that there may be any alternate number of caliper plates adjustable along respective rails (e.g., one, two, four, etc.). While three sensors 106a-106c (each detecting movement of a respective caliper plate) is described, it is generally contemplated that there may be any alternate suitable number of sensors (e.g., one sensor for the system 100, multiple sensors per caliper plate, etc.).

Generally, the sensors 106a, 106b, 106c determine the distance between an initial position of a caliper plate 102a, 102b, 102c and a final position of a caliper plate 102a, 102b, 102c (e.g., when the caliper plate is in contact with a respective side of the item being measured). Specifically, the first sensor 106a may detect a final position of the first caliper plate 102a while the first caliper plate 102a is in contact with a first side of an item being measured, the second sensor 106b may detect a final position of the second caliper plate 102b while the second caliper plate 102b is in contact with a second side of the item, and the third sensor 106c may detect a final position of the third caliper plate 102c while the third caliper plate 102c is in contact with a third side of the item. In some aspects, the system 100 determines a first distance between the initial position and the final position of the first caliper plate 102a, a second distance between the initial position and the final position of the second caliper plate 102b, and a third distance between the initial position and the final position of the third caliper late 102c.

In some aspects, the system 100 obtains measurement data from at least one sensor. Generally, the measurement data indicates a distance moved by each of the caliper plates 102a, 102b, 102c along their respective rails 104a-104c (in their respective axes) from an initial position to a final position in which each of the caliper plates 102a-102c is in contact with a respective side of the item being measured. The system 100 further processes the measurement data received from the at least one sensor 106a-106c to determine overall dimensions (e.g., length, width, depth, height, circumference, etc.) of the item being measured. In some forms, after the overall dimensions of an item are determined, the overall dimensions are output (e.g., on a display of a user interface) to visually indicate a numerical value (e.g., in units of measurement including inches, centimeters, etc.) representing the overall dimensions of the item.

In some aspects, the system 100 obtains measurement data associated with the first caliper plate 102a, obtains measurement data associated with the second caliper plate 102b, and obtains measurement data associated with the third caliper plate 102c. In some embodiments, the system 100 processes the measurement data associated with the first caliper plate 102a and the first distance to determine a first dimension of the item along the first axis, processes the measurement data associated with the second caliper plate 102b and the second distance to determine a second dimension of the item along the second axis, and processes the measurement data associated with the third caliper plate 102c and the third distance to determine a third dimension of the item along the third axis. In some aspects, the first dimension is associated with a width of the item, the second dimension is associated with a depth of the item, and the third dimension is associated with a height of the item.

In some aspects, the system 100 may include additional sensors in accordance with some embodiments. For example, the system 100 may include temperature sensors and/or humidity sensors for monitoring the ambient environment. It is contemplated that humidity and/or temperature may affect the accuracy of the sensors 106a, 106b, 106c (and in particular, lidar and/or ultrasonic sensors). Temperature and/or humidity sensors may be used to monitor the ambient environment in which the system 100 resides and/or to continuously monitor and maintain the humidity and temperature of the ambient environment in an optimal range for operation of the sensors 106a, 106b, 106c.

Further referring to FIG. 1B, a process 111 of operating the system 100 is shown in accordance with some embodiments. Generally, the process 111 shown in FIG. 1B is a process for operating a manual item measurement system, such as the system 100. In some aspects, at step 112, a product (e.g., the item being measured) may be placed onto the device (e.g., the platform 108 of the system 100). At step 114, the caliper plates 102a, 102b, 102c are moved (e.g., manually by an operator) into position against the product. At step 116, a button is pressed (e.g., on a user interface of the system 100) to begin measurement capture (e.g., by the sensors 106a, 106b, 106c). At step 118, a readout (e.g., a visual record or display such as, on a display of a user interface of the system 100) is taken from the measurements captured. While step 116 describes a button being pressed to start measurement, it is contemplated that any alternate mechanism may be used to initiate/activate the measurement of an item and/or that in some aspects, the measurements of the item may be taken continuously (e.g., step 116 may be optional).

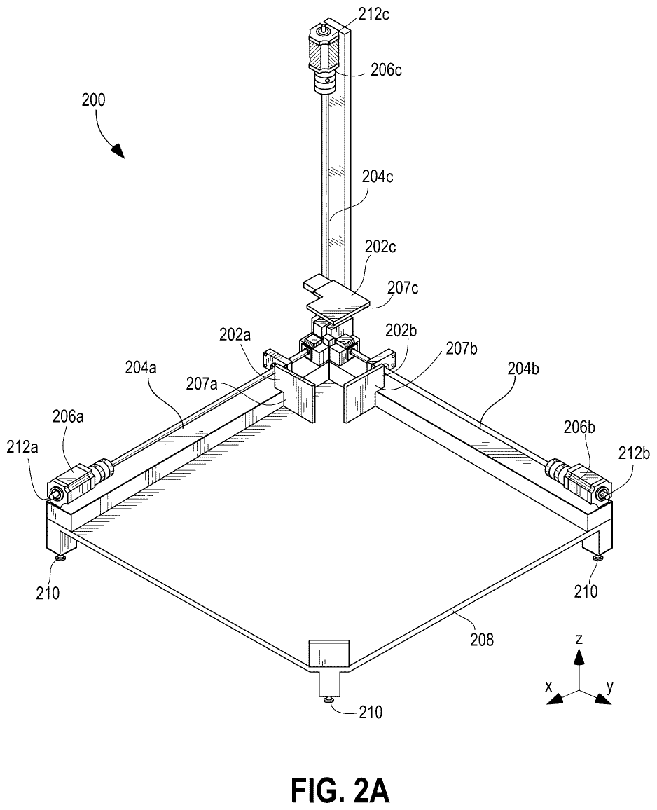

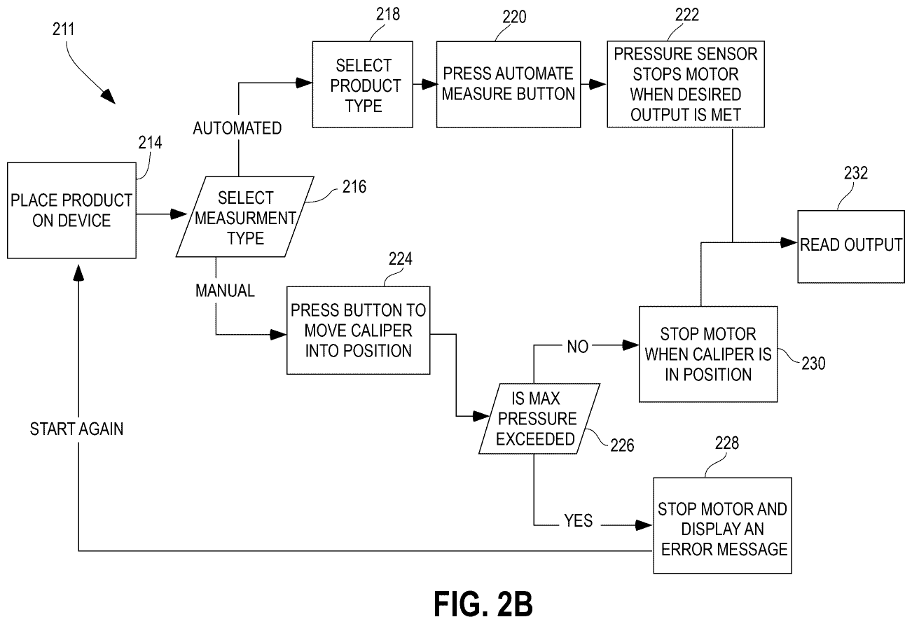

Further referring to FIG. 2A, a system 200 for determining item dimensions is shown in accordance with some embodiments. It is generally contemplated that the system 200 may be similar to the system 100 such that the system 200 includes components of the system 100. It is generally contemplated that the system 100 is a manual mechanism, and that the system 200 is an automated mechanism (e.g., the system 200 is akin to the system 100 but further includes automated components). The system 200 includes a plurality of caliper plates 202a, 202b, 202c (movable along respective rail 204a, 204b, 204c in respective axes), a plurality of sensors 206a, 206b, 206c, a platform 208, and supports 210 which are generally contemplated to be the same as the caliper plates 102a, 102b, 102c, the sensors 106a, 106b, 106c, the platform 108, and the supports 110 of the system 100 shown in FIG. 1A, such that these components require no further explanation.

As shown, the system 200 further includes a respective motor 212a, 212b, 212c operatively coupled to each of the caliper plates 202a, 202b, 202c. Each motor 212a, 212b, 212c may be actuated to adjust the location of each of the caliper plates 202a, 202b, 202c along their respective rails 204a, 204b, 204c in a direction toward a respective side of an item being measured. In some aspects, the motors 212a, 212b, 212c are stepper and/or servo motors. Suitable motors may include induction motors, synchronous motors, permanent magnet motors, brushed electric motors, brushless electric motors, servomotors, stepper motors, electric motors, and so forth. In some aspects, when the system 200 includes motors 212a, 212b, 212c, the sensors 206a, 206b, 206c (specifically, sensors that detect a range of movement of a respective caliper plate 202a, 202b, 202c) may be in the form of rotary encoders (e.g., absolute linear and/or carriage screw mounted) instead of and/or in addition to ultrasonic and/or lidar sensors.

In some embodiments, the system 200 further includes at least one pressure sensor (e.g., force and/or torque sensors). Generally, each caliper plate 202a, 202b, 202c is physically coupled to a respective pressure sensor 207a, 207b, 207c such that the system 200 can obtain pressure data indicating a pressure exerted by each of the caliper plates 202a, 202b, 202c on a respective side of the item being measured. In some aspects, the system 200 may determine that one or more of the caliper plates 202a, 202b, 202c is exerting a pre-determined threshold pressure on the respective side of the item, and actuation of the respective motor 212a, 212b, 212c is stopped in order to stop movement of the respective caliper plates 202a, 202b, 202c in the direction toward the respective side of the item (e.g., to prevent physical damage to the item). In some embodiments, item specific information (e.g., item type, fragility, etc.) may be provided to the system 200 (e.g., via a user interface), and the item-specific information may include a pressure threshold (e.g., the pre-determined pressure) appliable to an exterior surface of the item by the caliper plates 202a, 202b, 202c. In some aspects, a non-item specific threshold pressure (e.g., an arbitrarily-chosen pressure, default threshold pressure, etc.) may cause the motors 212a, 212b, 212c to stop actuation when sensed by a respective pressure sensor 207a, 207b, 207c.

Further referring to FIG. 2B, a process 211 of operating the system 200 is shown in accordance with some embodiments. Generally, the process 211 shown in FIG. 2B is a process for operating an automatic item measurement system (e.g., the system 200) which includes pressure sensors (e.g., pressure sensors 207a, 207b, 207c). In some aspects, at step 214, an item to be measured is placed on the device (e.g., on the platform 208). At step 216, a measurement type (e.g., manual, or automated (relative to the actuation of the motors 212a, 212b, 212c)) is selected (e.g., via an interface of a user device).

In embodiments where automated measurement is selected, at step 218 a product type (e.g., boxed, bagged, fragile, specific kind of product, etc.) is selected (e.g., via an interface of a user device). At step 220, a button (e.g., on a user device) is pressed to begin automated measurement. At step 222, when a desired threshold pressure is sensed by a pressure sensor (e.g., the pressure sensors 207a, 207b, 207c), the motor (e.g., motors 212a, 212b, 212c) stops movement of the caliper plates (e.g., caliper plates 202a, 202b, 202c) in the direction of the product being measured.

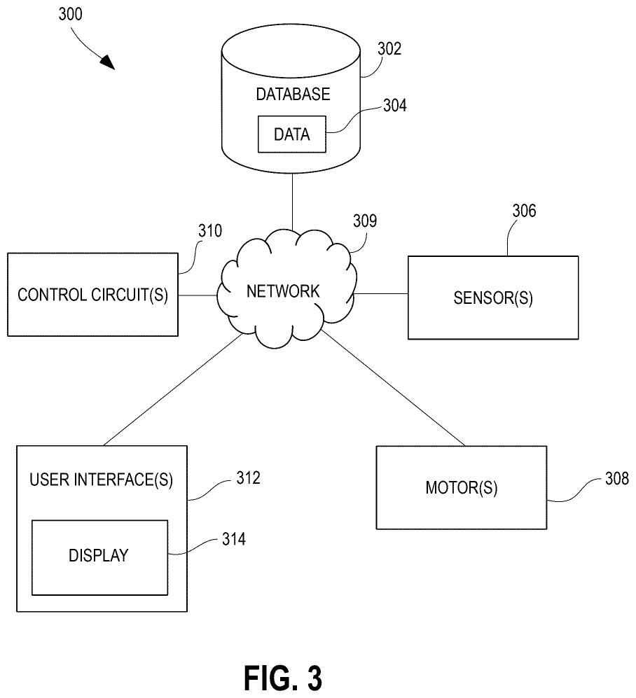

In embodiments where manual measurement is selected, at step 224, a button (e.g., on a user device) is pressed to move the caliper plates (e.g., caliper plates 202a, 202b, 202c) into position (e.g., by actuating the motors 212a, 212b, 212c). At step 226, it is determined by a computing device (e.g., the control circuit 310 shown in FIG. 3) whether the maximum pressure threshold has been exceeded (e.g., by pressure sensors). If the maximum pressure has been exceeded, at step 228 the motors (e.g., motors 212a, 212b, 212c) are stopped and an error message is displayed (e.g., on a display of a user device). As shown by the “Start Again” arrow in FIG. 2B, the process 211 may be repeated from step 214 to step 228. If the maximum pressure threshold has not been exceeded, at step 230, the motors (e.g., the motors 212a, 212b, 212c) are stopped when the caliper plates (e.g., the caliper plates 202a, 202b, 202c) are in position (e.g., in contact with a respective side of an item being measured and/or once the indicated pressure has been sensed by the pressure sensors 207a, 207b, 207c).

Following step 222 and/or step 230 (depending on the measurement type selected at step 216), at step 232, the item dimensions measured are output (e.g., via a display of a user device) and may be read by a user (e.g., operator of the system 200).

Further referring to FIG. 3, a system 300 is shown in accordance with some embodiments. In some aspects, the system 300 includes and/or cooperates with the systems 100, 200 and/or components of the systems 100, 200. As shown, the system 300 includes a database 302, sensors 306, motors 308, a control circuit 310, and a user interface 312 communicatively coupled over a network 309.

The database(s) 302 are any suitable databases (e.g., hierarchical databases, relational databases, non-relational databases, object-oriented databases, and so forth) for storing data 304 relevant to the systems 100, 200, 300. In some aspects, the data 304 includes item information, historical measurement data, pressure thresholds, and/or any additional relevant information. In some aspects, the data 304 includes at least one of measurement data detected by at least one sensor 306, overall dimensions of an item determined by the control circuit 310, a type of the item (e.g., glass, dog food, pillow, etc.), an identity of the physical characteristics of the item (e.g., fragile, compressible, stiff, etc.), a pressure threshold that may be applied to an exterior surface of the item by the caliper plates, etc.

The sensors 306 are generally contemplated to be the same and/or similar to the sensors 106a, 106b, 106c, 206a, 206b, 206c, 207a, 207b, 207c described herein. For example, the sensors 306 may include lidar sensors, ultrasonic sensors, rotary encoders, temperature sensors, humidity sensors, pressure sensors, and so forth. The sensor 306 may determine a distance between an initial position and a final position of a caliper plate, determine the humidity and/or temperature in the ambient environment, determine the pressure exerted by a caliper plate on the item being measured, and so forth.

The motors 308 are generally contemplated to be the same as the motors 212a, 212b, 212c described herein. For example, suitable motors 308 may include induction motors, synchronous motors, permanent magnet motors, brushed electric motors, brushless electric motors, servomotors, electric motors, and so forth. Generally, the motors 308 are coupled with a respective caliper plate and actuation of the motors 308 causes movement of the caliper plate in a designated direction (e.g., towards an item being measured (during item measurement) and/or towards an initial position of a caliper plate (e.g., after an item has been measured)).

The control circuit 310 is a processor-based control circuit in accordance with some embodiments. In some aspects, the control circuit 310 may include any suitable processing resource configured to execute instructions stored in a computer-readable storage memory (e.g., a non-transitory, computer-readable storage medium). In this context, the terms control circuit and controller refer broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The control circuit 310 or controller may be configured (for example, by using corresponding programming stored in a memory as will be well understood by those skilled in the art) to carry out one or more of the steps, actions, and/or functions described herein.

In some aspects, instructions executable by the control circuit 310 are stored in a computer readable storage memory. The computer readable storage memory may store any additional data relevant to the systems 100, 200, 300 (e.g., item data, training data, historical inputs,, and the like). Examples of suitable computer readable storage memory includes random access memory (RAM), read-only memory (ROM), erasable programmable read-only memory (EPROM/flash memory), and so forth, and may include transient and/or non-transient mediums. The computer readable storage memory typically includes one or more processor-readable and/or computer-readable media accessed by at least the control circuit 310, and can include volatile and/or nonvolatile media, such as RAM, ROM, EEPROM, flash memory and/or other memory technology. The computer readable storage memory can be internal, external, or a combination of internal and external memory of the control circuit 310.

It is generally contemplated that the control circuit 310 is communicatively coupled (e.g., over the network 309) with and able to control operation of at least the sensors 306, the motors 308, and/or the user interface 312. For example, the control circuit 310 may actuate and/or obtain measurement data from the sensors 306 and process the measurement data in order to determine overall dimensions of an item being measured. Further, the control circuit 310 may obtain sensor data representing the distance between an initial position of a caliper plate and a final position of a caliper plate measured by a respective sensor, and, based on processing this sensor data, determine the item's dimensions using the determined distance and the measurement data. In other words, in some aspects, the control circuit 310 is programmed to consider the length of an axis upon which a caliper plate is moveable as “1,” and the distance between the initial position of the caliper plate and the final position of the caliper plate as “n.” The control circuit 310, in some aspects, may be programmed to determine a dimension “d” of an item by subtracting n from 1, (i.e., 1−n=d). In some aspects, after the control circuit 310 determines the overall dimensions of an item being measured, the control circuit 310 transmits a signal (e.g., over the network 309) that causes a display 314 of the user interface 312 to visually indicate a numerical value representing the overall dimensions (e.g., width, depth, height) of the item being measured.

In some aspects, the control circuit 310 actuates the motors 308, and stops actuation of the motors 308 upon receipt from a pressure sensor (of the sensors 306) that a threshold pressure is being exerted by a respective caliper plate. The control circuit 310 may further determine that the pressure sensed by the pressure sensor is above the threshold pressure that may be exerted on the item being measured without physically damaging this item. The control circuit 310 may control movement of each of the caliper plates individually via the motors 308 such that the control circuit 310 may cause each caliper plate to move independently of one another.

In some aspects, the control circuit 310 further receives additional data from the sensors 306 including temperature and/or humidity data and responsively controls the temperature and/or humidity (e.g., by maintaining the temperature and/or humidity of the ambient environment in a pre-determined range).

The user interface 312 may be operatively coupled to the any described components of the systems 100, 200, 300 and may include, but is not limited to, smartphones, tablets, laptops, computers, and/or other such computing systems that enable a user to communicate with the systems 100, 200, 300. In some aspects, one or more user interfaces 312 may be part of the system 100 and/or one or more user interfaces 312 may be separate and distinct from the systems 100, 200, 300. The systems 100, 200, 300 can further include and/or be in communication with one or more networks 309. The user interface(s) 312 can allow a user to interact with the systems 100, 200, 300 and receive information through the systems 100, 200, 300.

In some instances, the user interface 312 includes a display 314 and/or one or more user inputs, such as buttons, touch screen, track ball, keyboard, mouse, etc., which can be coupled via a wired connection or wirelessly coupled with the systems 100, 200, 300. In some aspects, the user interface(s) 312 is a mobile device. Exemplary mobile devices may include, but are not limited to, cellular telephones, smartphones, tablets, portable computers, laptop computers, personal digital assistants, wearable devices, watches, eyeglasses, goggles, media players vehicle displays, and the like. In some aspects, the user interface 312 permits a user to input at least one attribute of the item being measured. In some forms, the attribute may include a type of item (e.g., glass, dog food, pillow, etc. ,) a physical characteristic of the item (e.g., fragile, compressible, stiff, etc.), and/or an operational parameter (e.g., pressure threshold) that may be applied to an exterior surface of the item by the caliper plates, and so forth.

The network 309 may be any suitable network or communication method such as, for example, a local area network (LAN), the Internet, wide area network (WAN), etc., communication link, other networks or communication channels with other devices and/or other such communications (not shown) or combination of two or more of such communication methods. There may be any combination of wired connections and/or wireless connections (e.g., Wi-Fi, Bluetooth, cellular, RF, and/or other such wireless communication) between elements of the systems 100, 200, 300.

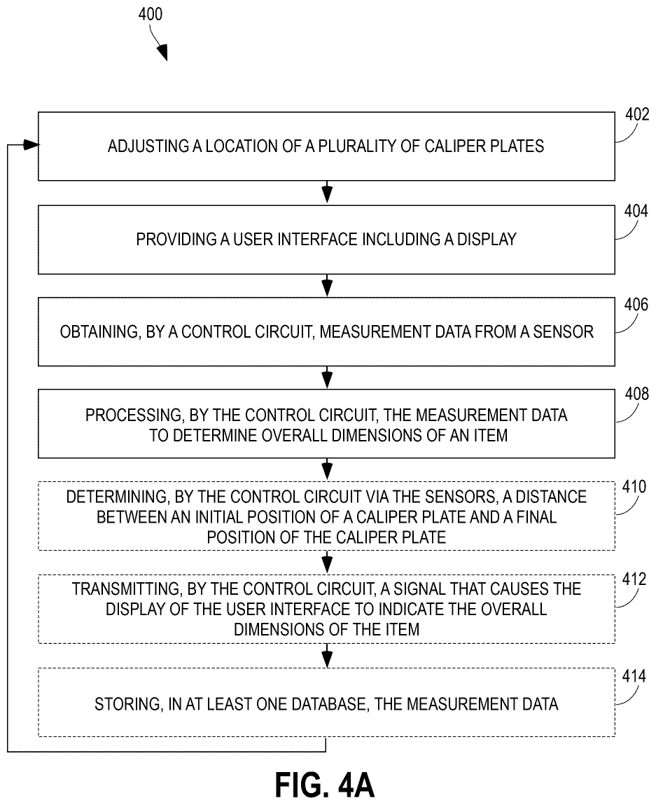

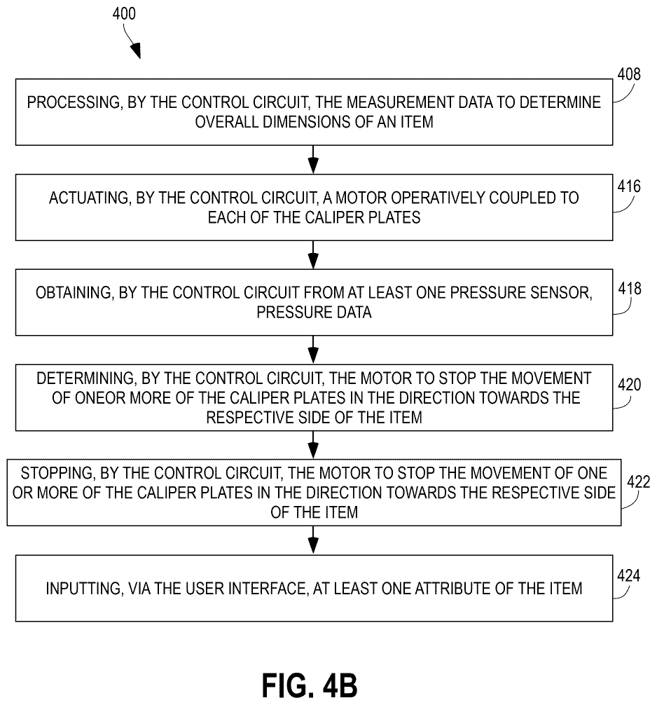

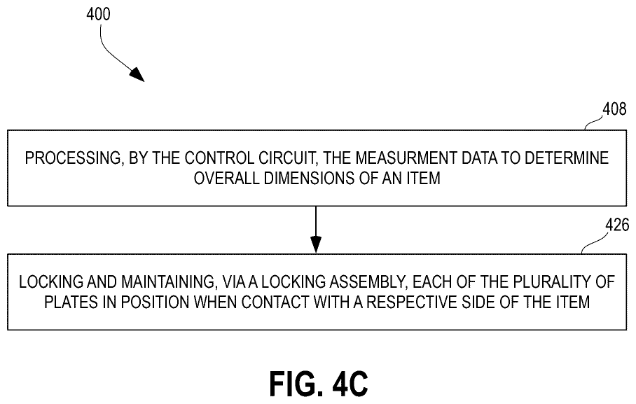

FIGS. 4A-4C are flow diagrams showing a method 400 in accordance with some embodiments. It is generally contemplated that the method 400 may be implemented by the systems 100, 200, 300 and/or components of the systems 100, 200, 300 and/or other systems. Generally, in accordance with some embodiment, the method 400 is used to determine dimensions of items.

Referring to FIG. 4A, at step 402 the method 400 includes adjusting a location of a plurality of caliper plates. In some aspects, a location of each of the caliper plates is adjustable along a respective rail in a respective axis. For example, a location of a first caliper plate may be adjustable along a first rail in a first axis, a location of a second caliper plate may be adjustable along a second rail in a second axis, and a location of a third caliper plate may be adjustable along a third rail in a third axis. At step 404, the method 400 includes providing a user interface using a display. In some aspects, a user may input information through the user interface provided.

At step 406, the method 400 includes obtaining, by a control circuit, from at least one sensor, of a plurality of sensors, measurement data indicating a distance moved by each of the caliper plates along their respective rail in their respective axis from an initial position to a final position. In some embodiments, in the final position, each of the caliper plates is in contact with a respective side of an item being measured. In some aspects, the at least one sensor includes at least one of a lidar sensor, an ultrasonic sensor, a rotary encoder, a temperature sensor, a humidity sensor, and/or a pressure sensor. For example, a range of movement of the first caliper plate may be detected by a first sensor of the plurality of sensors, a range of movement of the second caliper plate may be detected by a second sensor of the plurality of sensors, and a range of movement of the third caliper plate may be detected by a third sensor of the plurality of sensors. At step 408, the method 400 includes processing, by the control circuit, the measurement data received from the at least one sensor to determine the overall dimensions of the item.

Optionally, at step 410, the method 400 may include determining, by the control circuit and via the sensors, a distance between an initial position of a caliper plate and a final position of the caliper plate. For example, the first sensor may determine a first distance between the initial position of the first caliper plate and the final position of the first caliper plate in which the first caliper plate is in contact with a first side of the item being measured. The second sensor may determine a second distance between the initial position of the second caliper plate and the final position of the second caliper plate in which the second caliper plate is in contact with a second side of the item. The third sensor may determine a third distance between the initial position of the third caliper plate and the final position of the third caliper plate in which the third caliper plate is in contact with a third side of the item.

In some aspects, the optional step 410 may be preceded by step 408 such that a distance between an initial position of a caliper plate and a final position of the caliper plate is determined prior to measurement data being received. For example, the control circuit may obtain measurement data associated with the first caliper plate and process the measurement data associated with the first caliper plate and the first distance to determine a first dimension of the item along the first axis. The control circuit may obtain measurement data associated with the second caliper plate and process the measurement data associated with the second caliper plate and the second distance to determine a second dimension of the item. The control circuit may obtain measurement data associated with the third caliper plate and process the measurement data associated with the third caliper plate and the third distance to determine a third dimension of the item. In some aspects, the first dimension is associated with a width of the item, the second dimension is associated with a depth of the item, and the third dimension is associated with a height of the item.

Optionally, at step 412, the method 400 may include transmitting, by the control circuit, a signal that causes the display of the user interface to visually indicate a numerical value representing the overall dimensions of the item. In some embodiments, step 412 is performed after the overall dimensions of the item are determined (i.e., after step 408). Optionally, at step 414, the method 400 may include storing data in at least one database. In some embodiments, the data that may be stored in the at least one database includes the measurement data detected by the at least one sensor, the overall dimensions of the item determined by the control circuit, a type of the item, physical characteristics of the item, an identity of the item, and a pressure threshold that may be applied to an exterior surface of the item by the caliper plates.

Further referring to FIG. 4B, in some embodiments, following step 408, the method 400 may optionally include steps 416, 418, 420, 422, and 424. In some aspects, FIG. 4B is implemented by an automated item measurement system (e.g., the system 200). At step 416, the method 400 may include actuating, by the control circuit, a motor operatively coupled respectively to each of the caliper plates to adjust the location of each one of the caliper plates by causing movement of the caliper plates along their respective axis in a direction toward a respective side of the item. In some aspects, each of the plurality of caliper plates is operatively coupled to a respective motor. At step 418, the method 400 may include obtaining pressure data by the control circuit from at least one pressure sensor, with the pressure data indicating a pressure exerted by the caliper plates on a respective side of the item being measured. At step 420, the method 400 may include determining, by the control circuit, that one or more of the caliper plates is exerting a pre-determined threshold pressure on the respective side of the item. At step 422, the method 400 may include stopping, by the control circuit, the motor operatively coupled respectively to the one or more of the caliper plates to stop the movement of the one or more caliper plates in the direction toward the respective side of the item. At step 424, the method 400 may further include inputting, via the user interface, at least one attribute of the item including but not limited to a type of the item, an identity of the item, physical characteristics of the item, and a pressure threshold that may be applied to an exterior surface of the item by the caliper plates. In some aspects, the pre-determined threshold pressure described relative to step 420 may be the pressure threshold associated with a specific item being measured.

Further referring to FIG. 4C, in some embodiments, following step 408, the method 400 may optionally include step 426. In some aspects, FIG. 4C is implemented by a manual item measurement system (e.g., the system 100). At step 426, the method 400 may include locking and maintaining, via a locking assembly, each of the plurality of caliper plates in position when each of the caliper plates is in contact with a respective side of the item.

Generally, the systems and methods described herein utilizes a caliper type cartesian measuring assembly which provides absolute measurement outputs in three axes relative to a fixed hard point upon which an item is positively referenced, also known as the reference point. Some embodiments utilize three caliper plate carriages, individually adjustable (e.g., along rails) in parallel to one of the three axes of measurement (e.g., x-axis, y-axis, and z-axis). A locking assembly may be used to lock and maintain applied caliper plate pressure to an item being measured, effectively locating the caliper plate directly adjacent to the item. In some aspects, sensors (e.g., ultrasonic/lidar) each statically affixed parallel to a unique axis of measurement (e.g., x-axis, y-axis, z-axis) just beyond the maximum measurement range of that axis, outputs a measurement value at a level of precision and accuracy defined by the sensor specifications and caliper plate pressure tolerance. The systems and methods described herein enable a simple and practical process of taking more accurate measurements of imperfect items by allowing an operator to selectively position the caliper plate sensor reference plane.

Those skilled in the art will recognize that a wide variety of other modifications, alterations, and combinations can also be made with respect to the above-described embodiments without departing from the scope of the disclosure, and that such modifications, alterations, and combinations are to be viewed as being within the ambit of the inventive concept.

1. A system for determining dimensions of items, the system comprising:
a plurality of caliper plates, wherein a location of each of the plurality of caliper plates is adjustable along a respective axis;
a plurality of sensors, wherein at least one sensor of the plurality of sensors is positioned to detect a range of movement of each of the caliper plates;
a user interface including a display; and
a control circuit that:
obtains, from the at least one sensor, measurement data indicating a distance moved by each of the caliper plates along their respective axis from an initial position to a final position, where each of the caliper plates is in contact with a respective side of an item; and
processes the measurement data received from the at least one sensor to determine overall dimensions of the item.

2. The system of claim 1, wherein the plurality of caliper plates further includes a first caliper plate, a second caliper plate and a third caliper plate, and wherein:
a range of movement of the first caliper plate is detected by a first sensor of the plurality of sensors and a location of the first caliper plate is adjustable along a first axis;
a range of movement of the second caliper plate is detected by a second sensor of the plurality of sensors and a location of the second caliper plate is adjustable along a second axis; and
a range of movement of the third caliper plate is detected by a third sensor of the plurality of sensors and a location of the third caliper plate is adjustable along a third axis.

3. The system of claim 2, wherein the control circuit further:
determines, via the first sensor, a first distance between the initial position of the first caliper plate and the final position of the first caliper plate, where the first caliper plate is in contact with a first side of the item;
determines, via the second sensor, a second distance between the initial position of the second caliper plate and the final position of the second caliper plate, where the second caliper plate is in contact with a second side of the item;
determines, via the third sensor, a third distance between the initial position of the third caliper plate and the final position of the third caliper plate, where the third caliper plate is in contact with a third side of the item;
obtains measurement data associated with the first caliper plate, and processes the measurement data associated with the first caliper plate and the first distance to determine a first dimension of the item along the first axis;
obtains measurement data associated with the second caliper plate, and processes the measurement data associated with the second caliper plate and the second distance to determine a second dimension of the item along the second axis; and
obtains measurement data associated with the third caliper plate, and processes the measurement data associated with the third caliper plate and the third distance to determine a third dimension of the item along the third axis;
wherein the first dimension is associated with a width of the item, the second dimension is associated with a depth of the item, and the third dimension is associated with a height of the item.

4. The system of claim 1, wherein:
each of the plurality of caliper plates is operatively coupled to a respective motor; and
the control circuit further actuates the motor operatively coupled respectively to each of the caliper plates to adjust the location of each one of the caliper plates by causing movement of each one of the caliper plates along their respective axis in a direction toward a respective side of the item.

5. The system of claim 4, wherein:
the at least one sensor includes at least one pressure sensor;
the control circuit obtains, from the at least one pressure sensor, pressure data indicating a pressure exerted by the caliper plates on a respective side of the item; and
when the control circuit determines that one or more of the caliper plates is exerting a pre-determined threshold pressure on the respective side of the item, the control circuit stops the motor operatively coupled respectively to the one or more of the caliper plates to stop the movement of the one or more of the caliper plates in the direction toward the respective side of the item.

6. The system of claim 5, wherein:
the user interface permits a user to input at least one attribute of the item, the at least one attribute including at least one of a type of the item, an identity of the item, a physical characteristic of the item, and a pressure threshold that may be applied to an exterior surface of the item by the caliper plates.

7. The system of claim 1, further including a locking assembly to lock and maintain each of the plurality of caliper plates in position when each of the caliper plates is in contact with a respective side of the item.

8. The system of claim 1, wherein the at least one sensor includes at least one of a lidar sensor, an ultrasonic sensor, a rotary encoder, a temperature sensor, and a humidity sensor.

9. The system of claim 1, wherein, after the control circuit determines the overall dimensions of the item, the control circuit transmits a signal that causes the display of the user interface to visually indicate a numerical value representing the overall dimensions of the item.

10. The system of claim 1, further comprising at least one database that stores data including at least one of: the measurement data detected by the at least one sensor, the overall dimensions of the item determined by the control circuit, a type of the item, an identity of the item, a physical characteristic of the item, and a pressure threshold that may be applied to an exterior surface of the item by the caliper plates.

11. A method for determining dimensions of items, the method comprising:
adjusting a location of a plurality of caliper plates, wherein a location of each of the plurality of caliper plates is adjustable along a respective axis;
providing a user interface including a display;
obtaining, by a control circuit, from at least one sensor, of a plurality of sensors, positioned to detect a range of movement of each of the caliper plates, measurement data indicating a distance moved by each of the caliper plates along their respective axis from an initial position to a final position, where each of the caliper plates is in contact with a respective side of an item; and
processing, by the control circuit, the measurement data received from the at least one sensor to determine overall dimensions of the item.

12. The method of claim 11, wherein the plurality of caliper plates further includes a first caliper plate, a second caliper plate and a third caliper plate, and wherein:
a range of movement of the first caliper plate is detected by a first sensor of the plurality of sensors and a location of the first caliper plate is adjustable along a first axis;
a range of movement of the second caliper plate is detected by a second sensor of the plurality of sensors and a location of the second caliper plate is adjustable along a second axis; and
a range of movement of the third caliper plate is detected by a third sensor of the plurality of sensors and a location of the third caliper plate is adjustable along a third axis.

13. The method of claim 12, further comprising, by the control circuit:
determining, via the first sensor, a first distance between the initial position of the first caliper plate and the final position of the first caliper plate, where the first caliper plate is in contact with a first side of the item;
determining, via the second sensor, a second distance between the initial position of the second caliper plate and the final position of the second caliper plate, where the second caliper plate is in contact with a second side of the item;
determining, via the third sensor, a third distance between the initial position of the third caliper plate and the final position of the third caliper plate, where the third caliper plate is in contact with a third side of the item;
obtaining measurement data associated with the first caliper plate, and processes the measurement data associated with the first caliper plate and the first distance to determine a first dimension of the item along the first axis;
obtaining measurement data associated with the second caliper plate, and processes the measurement data associated with the second caliper plate and the second distance to determine a second dimension of the item along the second axis; and
obtaining measurement data associated with the third caliper plate, and processes the measurement data associated with the third caliper plate and the third distance to determine a third dimension of the item along the third axis;
wherein the first dimension is associated with a width of the item, the second dimension is associated with a depth of the item, and the third dimension is associated with a height of the item.

14. The method of claim 11, wherein each of the plurality of caliper plates is operatively coupled to a respective motor, the method further comprising:
actuating, by the control circuit, the motor operatively coupled respectively to each of the caliper plates to adjust the location of each one of the caliper plates by causing movement of each one of the caliper plates along their respective axis in a direction toward a respective side of the item.

15. The method of claim 14, wherein the at least one sensor includes at least one pressure sensor, the method further comprising, by the control circuit:
obtaining, from the at least one pressure sensor, pressure data indicating a pressure exerted by the caliper plates on a respective side of the item;
determining that one or more of the caliper plates is exerting a pre-determined threshold pressure on the respective side of the item; and
stopping the motor operatively coupled respectively to the one or more of the caliper plates to stop the movement of the one or more of the caliper plates in the direction toward the respective side of the item.

16. The method of claim 15, further comprising inputting, via the user interface, at least one attribute of the item, the at least one attribute including at least one of a type of the item, an identity of the item, a physical characteristic of the item, and a pressure threshold that may be applied to an exterior surface of the item by the caliper plates.

17. The method of claim 11, further comprising locking and maintaining, via a locking assembly, each of the plurality of caliper plates in position when each of the caliper plates is in contact with a respective side of the item.

18. The method of claim 11, wherein the at least one sensor includes at least one of a lidar sensor, an ultrasonic sensor, a rotary encoder, a temperature sensor, and a humidity sensor.

19. The method of claim 11, wherein, after determining, by the control circuit, the overall dimensions of the item, the method further comprises transmitting, by the control circuit, a signal that causes the display of the user interface to visually indicate a numerical value representing the overall dimensions of the item.

20. The method of claim 11, further comprising storing, in at least one database, data including at least one of: the measurement data detected by the at least one sensor, the overall dimensions of the item determined by the control circuit, a type of the item, an identity of the item, a physical characteristic of the item, and a pressure threshold that may be applied to an exterior surface of the item by the caliper plates.
